(19) United States
(12) Patent Application Publication
(10) Pub. No.: US 2023/0266941 A1
(43) Pub. Date: Aug. 24, 2023

(54) Floating Point Number Calculation Circuit and Floating Point Number Calculation Method

(71) Applicant: Huawei Technologies Co., Ltd., Shenzhen (CN)

(72) Inventors: Donglong Jiang, Shanghai (CN); Zhenjiang Dong, Shenzhen (CN); Huan Xie, Shanghai (CN); Chun Hang Lee, Hong Kong (CN)

(21) Appl. No.: 18/309,269

(22) Filed: Apr. 28, 2023

Related U.S. Application Data
(63) Continuation of application No. PCT/CN2020/125676, filed on Oct. 31, 2020.

(51) Int. Cl. G06F 7/485; G06F 5/01

(52) U.S. Cl. CPC G06F 7/485; G06F 5/012

(57) ABSTRACT

A splitting circuit included in a floating-point number calculation circuit splits a mantissa part of a first floating-point number and a mantissa part of a second floating-point number. An exponential processing circuit obtains a second number of shifted bits of each mantissa part obtained after splitting. A calculation circuit calculates a product of the mantissa part of the first floating-point number and the mantissa part of the second floating-point number based on each mantissa part obtained after splitting and the second number of shifted bits of each mantissa part obtained after splitting. The floating-point number calculation circuit can split a large bit-width floating-point number into small bit-width floating-point numbers, so that a small bit-width multiplier is used to calculate the large bit-width floating-point number.

### CROSS-REFERENCE TO RELATED APPLICATIONS

This is a continuation of International Patent Application No. PCT/CN2020/125676 filed on Oct. 31, 2020, the disclosure of which is hereby incorporated by reference in its entirety.

### TECHNICAL FIELD

Embodiments of this disclosure relate to the computer field, further to an application of an artificial intelligence (AI) technology in the computer field, and in particular, to a floating-point number calculation circuit and a floating-point number calculation method.

### BACKGROUND

AI is a theory, a method, a technology, or an application system that simulates, extends, and expands human intelligence by using a digital computer or a machine controlled by a digital computer, to perceive an environment, obtain knowledge, and achieve an optimal result based on the knowledge. In other words, AI is a branch of computer science and attempts to understand essence of intelligence and produce a new intelligent machine that can react in a similar manner to human intelligence. AI is to research design principles and implementation methods of various intelligent machines, so that the machines have perception, inference, and decision-making functions. Research in the field of AI includes robotics, natural language processing, computer vision, decision-making and inference, man-machine interaction, recommendation and search, AI basic theories, and the like.

Currently, a convolutional neural network (CNN) is widely used in a plurality of types of image processing applications. In such applications, when floating-point 16 (FP16) data is used to perform network training on a model, network training is not converged or a convergence speed is low due to low precision of the FP16 data. Therefore, higher-precision floating-point 32 (FP32) data is required to ensure network training effect. In addition, in a supercomputing application, higher-precision floating-point 64 (FP64) data is required for numerical calculation.

In an existing data calculation solution, a large bit-width multiplier is usually used to calculate data. For example, a multiplier for calculating FP64 data is usually reused to calculate the FP64 data and FP32 data. In an existing calculation solution, a 54-bit multiplier is designed to directly support calculation of a mantissa of the FP64 data. When the multiplier is used to calculate the FP32 data, the 54-bit multiplier is logically divided into two 27-bit parts to support calculation of mantissa parts of two pairs of FP32 data. As for processing of an exponential (exp) part, an eap processing unit of the FP64 part is directly copied to process the extra eap part of the FP32. However, in terms of an area ratio, area overheads of an FP64 multiplier are approximately equal to those of four FP32 multipliers. When the FP64 multiplier is reused to calculate the FP32 data, the FP64 multiplier implements only two times higher than calculation performance of the FP32 multiplier and the FP64 multiplier also has large timing overheads and high hardware design costs. Therefore, when the large bit-width multiplier is used to calculate the data, timing overheads, a hardware design and the like are unsatisfactory.

### SUMMARY

Embodiments of this disclosure provide a floating-point number calculation circuit and a floating-point number calculation method. The floating-point number calculation circuit can split a large bit-width floating-point number into small bit-width floating-point numbers, so that a small bit-width multiplier is used to calculate the large bit-width floating-point number. The floating-point number calculation circuit has small timing overheads, and low hardware design costs. Therefore, calculation performance of the multiplier is appropriately used.

A first aspect of embodiments of this disclosure provides a floating-point number calculation circuit. The floating-point number calculation circuit includes a memory controller, a splitting circuit, a storage circuit, an exponential processing circuit, and a calculation circuit. An input terminal of the splitting circuit is electrically connected to an output terminal of the memory controller, and an output terminal of the splitting circuit is electrically connected to an input terminal of the storage circuit. An input terminal of the exponential processing circuit is electrically connected to a first output terminal of the storage circuit, and an output terminal of the exponential processing circuit is electrically connected to a first input terminal of the calculation circuit. A second input terminal of the calculation circuit is electrically connected to a second output terminal of the storage circuit. The memory controller is configured to obtain a first floating-point number and a second floating-point number. The splitting circuit is configured to split a mantissa part of the first floating-point number and a mantissa part of the second floating-point number, and obtain a first number of shifted bits of each mantissa part obtained after splitting. The storage circuit is configured to store each mantissa part obtained after splitting, an exponential part corresponding to each mantissa part obtained after splitting, and the first number of shifted bits of each mantissa part obtained after splitting. The exponential processing circuit is configured to: add an exponential part of the first floating-point number and an exponential part of the second floating-point number to obtain a first operation result, add the first number of shifted bits of each mantissa part obtained after splitting and the exponential part corresponding to each mantissa part obtained after splitting to obtain a plurality of second operation results, and obtain, based on the plurality of second operation results, a second number of shifted bits of each mantissa part obtained after splitting. The calculation circuit is configured to calculate a product of the mantissa part of the first floating-point number and the mantissa part of the second floating-point number based on each mantissa part obtained after splitting and the second number of shifted bits of each mantissa part obtained after splitting.

An embodiment of this disclosure provides a floating-point number calculation circuit. A splitting circuit included in the floating-point number calculation circuit splits a mantissa part of a first floating-point number and a mantissa part of a second floating-point number. An exponential processing circuit obtains a second number of shifted bits of each mantissa part obtained after splitting. A calculation circuit calculates a product of the mantissa part of the first floating-point number and the mantissa part of the second floating-point number based on each mantissa part obtained after splitting and the second number of shifted bits of each mantissa part obtained after splitting. The floating-point number calculation circuit can split a large bit-width floating-point number into small bit-width floating-point numbers, so that a small bit-width multiplier is used to calculate the large bit-width floating-point number. The floating-point number calculation circuit provided in this disclosure has small timing overheads and low hardware design costs. Therefore, calculation performance of the multiplier is appropriately used.

In a possible implementation of the first aspect, the splitting circuit is configured to split the mantissa part of the first floating-point number into a first high-order mantissa and a first low-order mantissa, and split the mantissa part of the second floating-point number into a second high-order mantissa and a second low-order mantissa. The first number of shifted bits indicates a shift difference between a most significant bit of each high-order mantissa and a most significant bit of each low-order mantissa.

In this possible implementation, according to the floating-point number calculation circuit provided in this disclosure, the large bit-width mantissa part of the first floating-point number can be split into the first high-order mantissa and the first low-order mantissa with a small bit width, and the large bit-width mantissa part of the second floating-point number can be split into the second high-order mantissa and the second low-order mantissa with a small bit width, so that a small bit-width multiplier is used to calculate the product of the mantissa parts obtained after splitting. This reduces hardware design costs, and calculation performance of the multiplier is appropriately used.

In a possible implementation of the first aspect, the first high-order mantissa includes a first mantissa, the first low-order mantissa includes a second mantissa, the second high-order mantissa includes a third mantissa, and the second low-order mantissa includes a fourth mantissa.

In this possible implementation, a specific splitting manner for a mantissa part of a floating-point number is provided. After a mantissa part of an FP32 floating-point number is split in this splitting manner, an FP16 multiplier can be used for calculation. Similarly, after a mantissa part of an FP64 floating-point number is split in this splitting manner, an FP32 multiplier can be used for calculation. After a mantissa part of a floating-point 128 (FP128) floating-point number is split in this splitting manner, an FP64 multiplier can be used for calculation. In this splitting manner, a small bit-width multiplier can be used to calculate a product of large bit-width mantissa parts.

In a possible implementation of the first aspect, the first high-order mantissa includes a first mantissa. The first low-order mantissa includes a second mantissa, a third mantissa, a fourth mantissa, and a fifth mantissa. The second high-order mantissa includes a sixth mantissa. The second low-order mantissa includes a seventh mantissa, an eighth mantissa, a ninth mantissa, and a tenth mantissa.

In this possible implementation, a specific splitting manner for a mantissa part of a floating-point number is provided. After a mantissa part of an FP64 floating-point number is split in this splitting manner, an FP16 multiplier can be used for calculation. Similarly, after a mantissa part of an FP128 floating-point number is split in this splitting manner, an FP32 multiplier can be used for calculation. In this splitting manner, a small bit-width multiplier can be used to calculate a product of large bit-width mantissa parts.

In a possible implementation of the first aspect, the exponential processing circuit includes a first adder, a selection circuit, and a second adder. An input terminal of the first adder is electrically connected to the first output terminal of the storage circuit, and an output terminal of the first adder is electrically connected to a first input terminal of the second adder. A second input terminal of the second adder is electrically connected to an output terminal of the selection circuit, and an output terminal of the second adder is electrically connected to the first input terminal of the calculation circuit. The first adder is configured to add the first number of shifted bits of each mantissa part obtained after splitting and the exponential part corresponding to each mantissa part obtained after splitting, to obtain the plurality of second operation results. The selection circuit is configured to select a largest value in the plurality of second operation results. The second adder is configured to subtract each second operation result from the largest value in the plurality of second operation results, to obtain the second number of shifted bits of each mantissa part obtained after splitting.

This possible implementation provides a specific implementation form of hardware, thereby improving implementation of this solution.

In a possible implementation of the first aspect, the calculation circuit includes a multiplier, a shift register, and a third adder. An input terminal of the multiplier is electrically connected to the second output terminal of the storage circuit, and an output terminal of the multiplier is electrically connected to a first input terminal of the shift register. A second input terminal of the shift register is electrically connected to the output terminal of the second adder. An output terminal of the shift register is electrically connected to an input terminal of the third adder. The multiplier is configured to respectively multiply all mantissa parts that are obtained after splitting and that include the first high-order mantissa and the first low-order mantissa by all mantissa parts that are obtained after splitting and that include the second high-order mantissa and the second low-order mantissa, to obtain a plurality of pieces of multiplication data. The shift register is configured to perform shift processing on the plurality of pieces of multiplication data based on the second number of shifted bits of each mantissa part obtained after splitting. The third adder is configured to perform an addition operation on a plurality of pieces of multiplication data obtained after shift processing, to obtain the product of the mantissa part of the first floating-point number and the mantissa part of the second floating-point number.

This possible implementation provides a specific implementation form of hardware, thereby improving implementation of this solution.

A second aspect of embodiments of this disclosure provides a floating-point number calculation method. The method includes: obtaining a first floating-point number and a second floating-point number; splitting a mantissa part of the first floating-point number and a mantissa part of the second floating-point number, and obtaining a first number of shifted bits of each mantissa part obtained after splitting; storing each mantissa part obtained after splitting, an exponential part corresponding to each mantissa part obtained after splitting, and the first number of shifted bits of each mantissa part obtained after splitting; adding an exponential part of the first floating-point number and an exponential part of the second floating-point number to obtain a first operation result, adding the first number of shifted bits of each mantissa part obtained after splitting and the exponential part corresponding to each mantissa part obtained after splitting to obtain a plurality of second operation results, and obtaining, based on the plurality of second operation results, a second number of shifted bits of each mantissa part obtained after splitting; and calculating a product of the mantissa part of the first floating-point number and the mantissa part of the second floating-point number based on each mantissa part obtained after splitting and the second number of shifted bits of each mantissa part obtained after splitting.

In this embodiment of this disclosure, the mantissa part of the first floating-point number and the mantissa part of the second floating-point number are split to obtain the second number of shifted bits of each mantissa part obtained after splitting. Then, the product of the mantissa part of the first floating-point number and the mantissa part of the second floating-point number is calculated based on each mantissa part obtained after splitting and the second number of shifted bits of each mantissa part obtained after splitting. In the method, a large bit-width floating-point number can be split into a small bit-width floating-point number, so that a small bit-width multiplier is used to calculate the large bit-width floating-point number. According to the floating-point number calculation method provided in this disclosure, a calculation apparatus has short timing overheads and low hardware design costs, and calculation performance of a multiplier included in the calculation apparatus is appropriately used.

In a possible implementation of the second aspect, the splitting a mantissa part of the first floating-point number and a mantissa part of the second floating-point number includes: splitting the mantissa part of the first floating-point number into a first high-order mantissa and a first low-order mantissa, and splitting the mantissa part of the second floating-point number into a second high-order mantissa and a second low-order mantissa. The first number of shifted bits indicates a shift difference between a most significant bit of each high-order mantissa and a most significant bit of each low-order mantissa.

In this possible implementation, according to the floating-point number calculation method provided in this disclosure, the large bit-width mantissa part of the first floating-point number can be split into the first high-order mantissa and the first low-order mantissa with a small bit width, the large bit-width mantissa part of the second floating-point number can be split into the second high-order mantissa and the second low-order mantissa with a small bit width, so that a small bit-width multiplier is used to calculate the product of the mantissa parts obtained after splitting. This reduces hardware design costs, and calculation performance of the multiplier is appropriately used.

In a possible implementation of the second aspect, the first high-order mantissa includes a first mantissa, the first low-order mantissa includes a second mantissa, the second high-order mantissa includes a third mantissa, and the second low-order mantissa includes a fourth mantissa.

In this possible implementation, a specific splitting manner for a mantissa part of a floating-point number is provided. After a mantissa part of an FP32 floating-point number is split in this splitting manner, an FP16 multiplier can be used for calculation. Similarly, after a mantissa part of an FP64 floating-point number is split in this splitting manner, an FP32 multiplier can be used for calculation. After a mantissa part of an FP128 floating-point number is split in this splitting manner, an FP64 multiplier can be used for calculation. In this splitting manner, a small bit-width multiplier can be used to calculate a product of large bit-width mantissa parts.

In a possible implementation of the second aspect, the first high-order mantissa includes a first mantissa. The first low-order mantissa includes a second mantissa, a third mantissa, a fourth mantissa, and a fifth mantissa. The second high-order mantissa includes a sixth mantissa. The second low-order mantissa includes a seventh mantissa, an eighth mantissa, a ninth mantissa, and a tenth mantissa.

In this possible implementation, a specific splitting manner for a mantissa part of a floating-point number is provided. After a mantissa part of an FP64 floating-point number is split in this splitting manner, an FP16 multiplier can be used for calculation. Similarly, after a mantissa part of an FP128 floating-point number is split in this splitting manner, an FP32 multiplier can be used for calculation. In this splitting manner, a small bit-width multiplier can be used to calculate a product of large bit-width mantissa parts.

A third aspect of embodiments of this disclosure provides a calculation apparatus. The calculation apparatus includes a control circuit and a floating-point number calculation circuit. The floating-point number calculation circuit calculates data under control of the control circuit. The floating-point number calculation circuit is the floating-point number calculation circuit described in any one of the first aspect or the possible implementations of the first aspect.

### BRIEF DESCRIPTION OF DRAWINGS

FIG. 1 is a diagram of a processing principle of a CNN according to an embodiment of this disclosure.

FIG. 2 is a schematic diagram of composition of an FP32 floating-point number according to an embodiment of this disclosure.

FIG. 3 is a schematic diagram of a structure of a floating-point number calculation circuit according to an embodiment of this disclosure.

FIG. 4 is a schematic diagram of an embodiment of a floating-point number calculation circuit according to an embodiment of this disclosure.

FIG. 5 is a schematic diagram of another structure of a floating-point number calculation circuit according to an embodiment of this disclosure.

FIG. 6 is a schematic diagram of another embodiment of a floating-point number calculation circuit according to an embodiment of this disclosure.

FIG. 7 is a schematic diagram of another embodiment of a floating-point number calculation circuit according to an embodiment of this disclosure.

FIG. 8 is a schematic diagram of another embodiment of a floating-point number calculation circuit according to an embodiment of this disclosure.

FIG. 9 is a schematic diagram of another embodiment of a floating-point number calculation circuit according to an embodiment of this disclosure.

FIG. 10 is a schematic diagram of another embodiment of a floating-point number calculation circuit according to an embodiment of this disclosure.

FIG. 11 is a schematic diagram of another embodiment of a floating-point number calculation circuit according to an embodiment of this disclosure.

FIG. 12 is a schematic diagram of another embodiment of a floating-point number calculation circuit according to an embodiment of this disclosure.

FIG. 13 is a schematic diagram of another embodiment of a floating-point number calculation circuit according to an embodiment of this disclosure.

### DESCRIPTION OF EMBODIMENTS

To make objectives, technical solutions, and advantages of this disclosure clearer, the following describes embodiments of this disclosure with reference to accompanying drawings. It is clear that the described embodiments are merely some rather than all of the embodiments of this disclosure. A person of ordinary skill in the art may learn that, as a new application scenario emerges, the technical solutions provided in embodiments of this disclosure are also applicable to a similar technical problem.

In this specification, claims, and accompanying drawings of this disclosure, the terms “first”, “second”, and the like are intended to distinguish between similar objects but do not necessarily indicate a specific order or sequence. It should be understood that data termed in such a way is interchangeable in proper circumstances, so that embodiments described herein can be implemented in other orders than the order illustrated or described herein. In addition, the terms “include”, “contain” and any other variants mean to cover the non-exclusive inclusion, for example, a process, method, system, product, or device that includes a list of steps or modules is not necessarily limited to those steps or modules, but may include other steps or modules not expressly listed or inherent to such a process, method, product, or device. Names or numbers of steps in this disclosure do not mean that the steps in the method procedure need to be performed in a time/logical sequence indicated by the names or numbers. An execution sequence of the steps in the procedure that have been named or numbered can be changed based on a technical objective to be achieved, provided that same or similar technical effect can be achieved.

AI is a theory, a method, a technology, or an application system that simulates, extends, and expands human intelligence by using a digital computer or a machine controlled by a digital computer, to perceive an environment, obtain knowledge, and achieve an optimal result based on the knowledge. In other words, AI is a branch of computer science and attempts to understand essence of intelligence and produce a new intelligent machine that can react in a similar manner to human intelligence. AI is to research design principles and implementation methods of various intelligent machines, so that the machines have perception, inference, and decision-making functions. Research in the field of AI includes robotics, natural language processing, computer vision, decision-making and inference, man-machine interaction, recommendation and search, AI basic theories, and the like.

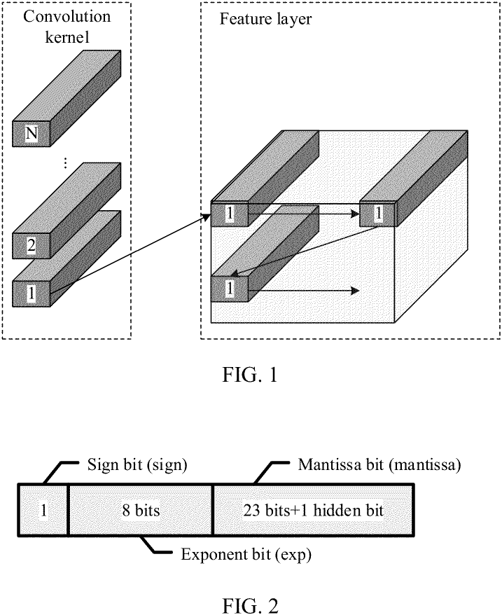

FIG. 1 is a diagram of a processing principle of a CNN according to this disclosure.

The CNN has a wide application prospect in the fields such as image, speech recognition, and the like. As shown in FIG. 1, the CNN needs to perform a convolution operation on a plurality of convolution kernels and one or more feature maps. Specifically, each convolution kernel moves pixel by pixel in the row direction from a first pixel of the feature map. When reaching an end point of this row, the convolution kernel moves down by one pixel in the column direction, returns to a start point in the row direction, and repeats the movement process in the row direction, until all pixels of the feature map are traversed. In the movement process of the convolution kernel, a parameter in the convolution kernel and data at a corresponding location in the feature map are used as two parts of inputs of a convolution operation, to perform a convolution operation (multiplying the two parts and then accumulating products one by one), obtain a convolution result, and output the convolution result.

Currently, the CNN is widely used in a plurality of types of image processing applications. In the image processing application, when FP16 data is used to perform network training on a model, network training is not converged or a convergence speed is low due to low precision of the FP16 data. Therefore, higher-precision FP32 data is required to ensure network training effect. In addition, in some applications, higher-precision FP64 data and FP128 data are required for model training.

It should be noted that, in addition to being used in the field of Al, the floating-point number calculation circuit in the present disclosure may be further used in the field of data signal processing, for example, an image processing system, a radar system, and a communication system. This circuit and method can optimize performance of digital signal processing (DSP) or other digital devices. For example, the circuit is used in a digital device in an existing communication system, for example, a Long-Term Evolution (LTE) system, a Universal Mobile Telecommunications System (UMTS), and a Global System for Mobile Communications (GSM).

In an existing data calculation solution, a large bit-width multiplier is usually used to calculate data. For example, a multiplier for calculating FP64 data is usually reused to calculate the FP64 data and FP32 data. In some calculation solutions, a 54-bit multiplier is designed to directly support calculation of a mantissa of the FP64 data. When the multiplier is used to calculate the FP32 data, the 54-bit multiplier is logically divided into two 27-bit parts to support calculation of mantissa parts of two pairs of FP32 data. However, in terms of an area ratio, area overheads of an FP64 multiplier are approximately equal to those of four FP32 multipliers. In the other technologies, when the FP64 multiplier is reused to calculate the FP32 data, the FP64 multiplier implements two times higher than calculation performance of the FP32 multiplier, and the FP64 multiplier also has large timing overheads and high hardware design costs. Therefore, when the large bit-width multiplier is used to calculate the data, timing overheads, a hardware design and the like are unsatisfactory.

For the foregoing problems in the existing data calculation solution, embodiments of this disclosure provide a floating-point number calculation circuit. A splitting circuit included in the floating-point number calculation circuit splits a mantissa part of a first floating-point number and a mantissa part of a second floating-point number, and obtains a first number of shifted bits of each mantissa part obtained after splitting. An exponential processing circuit adds the first number of shifted bits of each mantissa part obtained after splitting and an exponential part corresponding to each mantissa part obtained after splitting, to obtain a plurality of second operation results, and obtains, based on the plurality of second operation results, a second number of shifted bits of each mantissa part obtained after splitting. A calculation circuit calculates a product of the mantissa part of the first floating-point number and the mantissa part of the second floating-point number based on each mantissa part obtained after splitting and the second number of shifted bits of each mantissa part obtained after splitting. The floating-point number calculation circuit can split a large bit-width floating-point number into small bit-width floating-point numbers, so that a small bit-width multiplier is used to calculate the large bit-width floating-point number. Therefore, calculation performance of the multiplier is appropriately used, timing overheads are small, and hardware design costs are low.

The following clearly describes the technical solutions in this disclosure with reference to the accompanying drawings in this disclosure. It is clear that the described embodiments are merely some rather than all of the embodiments of this disclosure. The following several specific embodiments may be combined with each other, and same or similar content is not repeatedly described in different embodiments. It should be further noted that lengths, widths, and heights (or thicknesses) of various components shown in embodiments of this disclosure are merely examples for description, and are not intended to limit the storage unit in this disclosure.

Currently, there are four common formats of floating-point numbers: FP16, FP32, FP64 and FP128. Each floating-point number includes three parts: a sign bit (sign), an exponent bit (exp), and a mantissa bit (mantissa). An actual value of a floating-point number is equal to sign _{*} 2^{exp} _{*} mantissa.

FIG. 2 is a schematic diagram of composition of an FP32 floating-point number according to an embodiment of this disclosure.

As shown in FIG. 2, the FP32 floating-point number has a 1-bit sign, an 8-bit exp, and a 24-bit mantissa, and a total of 32 bits stored are displayed. A most significant bit of the mantissa is implicitly stored (if exp is not 0, the hidden bit is 1, otherwise, the hidden bit is 0). There are a total of 32 bits in three parts.

When a floating-point number A*B is calculated, a calculation process of an exponential part is A _exp+B_exp, and a calculation process of a mantissa part is A_mantissa*B_mantissa. Then, a newly obtained exp and mantissa are used to generate a new floating-point number according to a format in a standard.

When a floating-point number A+B is calculated, a larger one between A_exp and B_exp is first calculated. It is assumed that A_exp is n greater than B_exp. When mantissas are added, B_mantissa needs to be first shifted rightwards by n bits, and then B_mantissa obtained after shifting is added to A_mantissa to obtain a new mantissa. Then, a new floating-point number is generated according to a standard. When a plurality of floating-point numbers are added together, a maximum exp is first obtained, mantissas are correspondingly shifted based on differences between the maximum exp and exps of all floating-point numbers, and then the mantissas obtained after shifting are added.

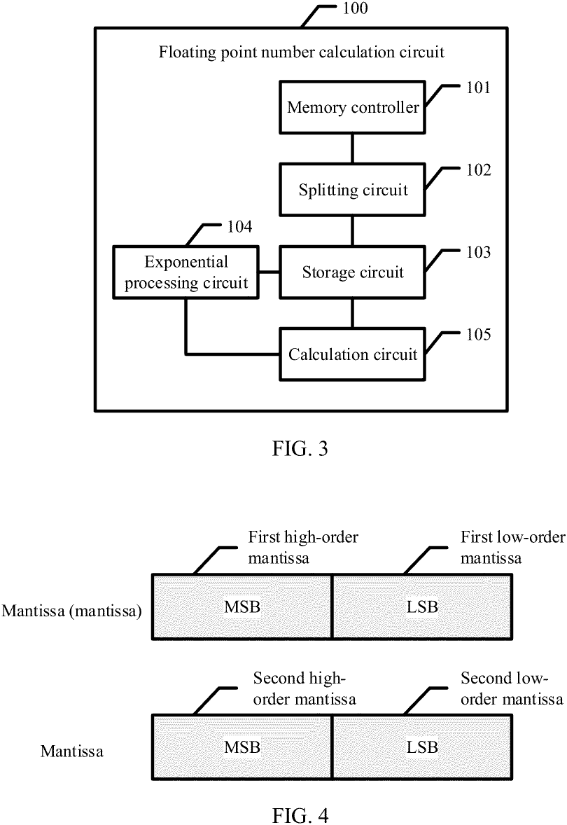

FIG. 3 is a schematic diagram of a structure of a floating-point number calculation circuit according to an embodiment of this disclosure.

Refer to FIG. 3. The floating-point number calculation circuit 100 provided in this disclosure includes a memory controller 101, a splitting circuit 102, a storage circuit 103, an exponential processing circuit 104, and a calculation circuit 105.

In this embodiment of this disclosure, an input terminal of the splitting circuit 102 is electrically connected to an output terminal of the memory controller 101, and an output terminal of the splitting circuit 102 is electrically connected to an input terminal of the storage circuit 103. An input terminal of the exponential processing circuit 104 is electrically connected to a first output terminal of the storage circuit 103, and an output terminal of the exponential processing circuit 104 is electrically connected to a first input terminal of the calculation circuit 105. A second input terminal of the calculation circuit 105 is electrically connected to a second output terminal of the storage circuit 103.

In this embodiment of this disclosure, a memory stores a first floating-point number and a second floating-point number, and the memory controller 101 is configured to obtain the first floating-point number and the second floating-point number. Optionally, the memory may be a double data rate (DDR) memory, or may be another memory. This is not specifically limited herein. The memory controller may be a DDR controller, or may be a memory controller of another type. This is not specifically limited herein.

In this embodiment of this disclosure, the splitting circuit 102 is configured to split a mantissa part of the first floating-point number and a mantissa part of the second floating-point number, and obtain a first number of shifted bits of each mantissa part obtained after splitting. The storage circuit is 103 configured to store each mantissa part obtained after splitting, an exponential part corresponding to each mantissa part obtained after splitting, and the first number of shifted bits of each mantissa part obtained after splitting.

For example, if the first floating-point number is an FP32 floating-point number, it is assumed that the mantissa part of the first floating-point number is 100000000000000000000001. The splitting circuit 102 may split the mantissa part of the first floating-point number into a part A whose length is 12 bits and a part B whose length is 12 bits. The part A is 100000000000, and the part B is 000000000001. If the part A is used as a reference, the part B obtained after splitting needs to be shifted rightwards by 12 bits, and then a result obtained after shifting is added to the part A to obtain the mantissa part of the first floating-point number. Therefore, the first number of shifted bits that is of the part B obtained after splitting and that is obtained by the splitting circuit 102 indicates to shift rightwards by 12 bits.

The foregoing splitting manner is merely used as an example for description. Optionally, the first floating-point number may be an FP32 floating-point number. Alternatively, the first floating-point number may be an FP64 floating-point number. Alternatively, the first floating-point number may be an FP128 floating-point number. This is not specifically limited herein. Optionally, when the mantissa part of the first floating-point number is split, the mantissa part may be split into two parts, or may be split into a plurality of parts. This is not specifically limited herein. All mantissa parts obtained after splitting may have a same number of bits, or all mantissa parts obtained after splitting may have a different number of bits. This is not specifically limited herein.

In this embodiment of this disclosure, a data type of the second floating-point number is similar to a data type of the first floating-point number, and a splitting manner for the mantissa part of the second floating-point number is similar to a splitting manner for the mantissa part of the first floating-point number. Details are not described herein again.

In this embodiment of this disclosure, the exponential processing circuit 104 is configured to add an exponential part of the first floating-point number and an exponential part of the second floating-point number to obtain a first operation result. The first operation result is an operation result of an exponential part obtained when the first floating-point number and the second floating-point number are multiplied. The exponential processing circuit 104 is further configured to: add the first number of shifted bits of each mantissa part obtained after splitting and an exponential part corresponding to each mantissa part obtained after splitting, to obtain a plurality of second operation results, and obtain, based on the plurality of second operation results, a second number of shifted bits of each mantissa part obtained after splitting. The calculation circuit 105 is configured to calculate a product of the mantissa part of the first floating-point number and the mantissa part of the second floating-point number based on each mantissa part obtained after splitting and the second number of shifted bits of each mantissa part obtained after splitting.

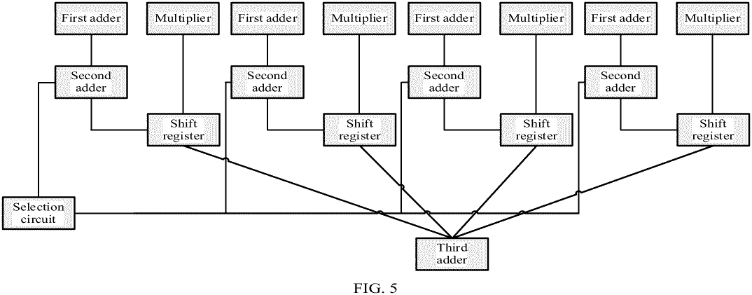

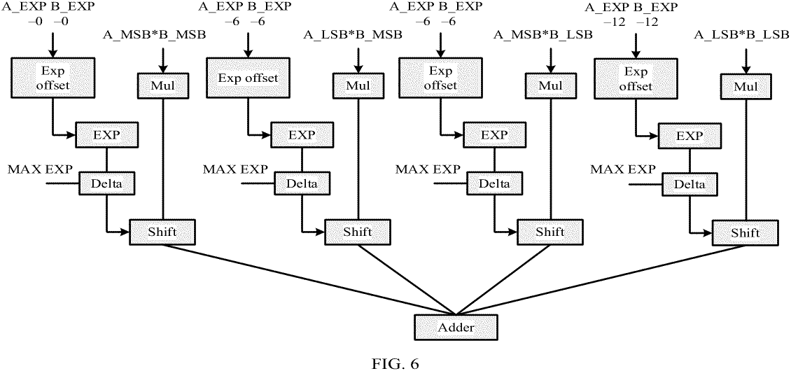

FIG. 4 is a schematic diagram of an embodiment of a floating-point number calculation circuit according to an embodiment of this disclosure.

Refer to FIG. 4. Optionally, the splitting circuit may split the mantissa part of the first floating-point number into a first high-order mantissa and a first low-order mantissa, and split the mantissa part of the second floating-point number into a second high-order mantissa and a second low-order mantissa. The first number of shifted bits indicates a shift difference between a most significant bit of each high-order mantissa and a most significant bit of each low-order mantissa.

In this disclosure, two specific splitting manners for the first high-order mantissa and the first low-order mantissa are provided, and are described in detail in the following embodiment.

Manner 1: The first high-order mantissa includes a first mantissa, the first low-order mantissa includes a second mantissa, the second high-order mantissa includes a third mantissa, and the second low-order mantissa includes a fourth mantissa.

For example, if the first floating-point number is an FP32 floating-point number, it is assumed that the mantissa part of the first floating-point number is 100000000011000000000001. The splitting circuit 102 may split the mantissa part of the first floating-point number into the first mantissa whose length is 11 bits and the second mantissa whose length is 13 bits. The first mantissa is 10000000001, and the second mantissa is 1000000000001.

In this embodiment, the first mantissa belongs to the first high-order mantissa, and the second mantissa belongs to the first low-order mantissa. The first number of shifted bits indicates the shift difference between the most significant bit of each high-order mantissa and the most significant bit of each low-order mantissa. To be specific, a number of shifted bits of the first mantissa is 0, and the first number of shifted bits of the second mantissa is a shift difference of 11 bits between a first bit of the second mantissa and a first bit of the first mantissa. Therefore, the first number of shifted bits of the second mantissa indicates to shift rightwards by 11 bits.

In this embodiment, a splitting manner for the second high-order mantissa is similar to that of the first high-order mantissa, and a splitting manner for the second low-order mantissa is similar to that for the first low-order mantissa. Details are not described herein again.

Manner 2: The first high-order mantissa includes a first mantissa, the first low-order mantissa includes a second mantissa, a third mantissa, a fourth mantissa, and a fifth mantissa, the second high-order mantissa includes a sixth mantissa, and the second low-order mantissa includes a seventh mantissa, an eighth mantissa, a ninth mantissa, and a tenth mantissa.

For example, if the first floating-point number is an FP64 floating-point number. It is assumed that the splitting circuit 102 may split the mantissa part of the first floating-point number into the first mantissa 10001 whose length is 5 bits, the second mantissa 100000000001 whose length is 12 bits, the third mantissa 100000000011 whose length is 12 bits, the fourth mantissa 100000000111 whose length is 12 bits, and the fifth mantissa 100000001111 whose length is 12 bits.

In this embodiment, the first mantissa belongs to the first high-order mantissa, and the second mantissa, the third mantissa, the fourth mantissa, and the fifth mantissa belong to the first low-order mantissa. The first number of shifted bits indicates a shift difference between a most significant bit of each high-order mantissa and a most significant bit of each low-order mantissa. To be specific, the number of shifted bits of the first mantissa is 0, and the first number of shifted bits of the second mantissa is a shift difference of five bits between a first bit of the second mantissa and a first bit of the first mantissa, and is the same as a number of bits of the first mantissa. Therefore, the first number of shifted bits of the second mantissa indicates to shift rightwards by five bits. The first number of shifted bits of the third mantissa is a shift difference of 17 bits between a first bit of the third mantissa and the first bit of the first mantissa, and is the same as a sum of numbers of shifted bits of the first mantissa and the second mantissa. Therefore, the first number of shifted bits of the third mantissa indicates to shift rightwards by 17 bits. The first number of shifted bits of the fourth mantissa is a shift difference of 29 bits between a first bit of the fourth mantissa and the first bit of the first mantissa, and is the same as a sum of numbers of shifted bits of the first mantissa, the second mantissa, and the third mantissa. Therefore, the first number of shifted bits of the fourth mantissa indicates to shift rightwards by 29 bits. The first number of shifted bits of the fifth mantissa is a shift difference of 41 bits between a first bit of the fifth mantissa and the first bit of the first mantissa, and is the same as a sum of numbers of shifted bits of the first mantissa, the second mantissa, the third mantissa, and the fourth mantissa. Therefore, the first number of shifted bits of the fifth mantissa indicates to shift rightwards by 41 bits.

In this embodiment, the first high-order mantissa and the second high-order mantissa may alternatively be split in another different manner. For example, the length of the first mantissa is 9 bits, and the lengths of the second mantissa, the third mantissa, the fourth mantissa, and the fifth mantissa are all 11 bits. This is not specifically limited herein.

In this embodiment, a splitting manner for the second high-order mantissa is similar to that of the first high-order mantissa, and a splitting manner for the second low-order mantissa is similar to that for the first low-order mantissa. Details are not described herein again.

In this embodiment of this disclosure, in addition to the splitting manners provided in Manner 1 and Manner 2, the floating-point number calculation circuit may further use another splitting manner when calculating a product of floating-point numbers. This is not specifically limited herein.

FIG. 5 is a schematic diagram of another structure of a floating-point number calculation circuit according to an embodiment of this disclosure.

Refer to FIG. 5, in this embodiment of this disclosure, an exponential processing circuit includes a first adder, a selection circuit, and a second adder.

In this embodiment of this disclosure, an input terminal of the first adder is electrically connected to a first output terminal of a storage circuit, and an output terminal of the first adder is electrically connected to a first input terminal of the second adder. A second input terminal of the second adder is electrically connected to an output terminal of the selection circuit, and an output terminal of the second adder is electrically connected to a first input terminal of a calculation circuit.

In this embodiment of this disclosure, the first adder is configured to add a first number of shifted bits of each mantissa part obtained after splitting and an exponential part corresponding to each mantissa part obtained after splitting, to obtain a plurality of second operation results. The selection circuit is configured to select a largest value in the plurality of second operation results. The second adder is configured to subtract each second operation result from the largest value in the plurality of second operation results, to obtain a second number of shifted bits of each mantissa part obtained after splitting.

Optionally, the calculation circuit may include a multiplier, a shift register, and a third adder.

In this embodiment of this disclosure, an input terminal of the multiplier is electrically connected to a second output terminal of the storage circuit, and an output terminal of the multiplier is electrically connected to a first input terminal of the shift register. A second input terminal of the shift register is electrically connected to an output terminal of the second adder. An output terminal of the shift register is electrically connected to an input terminal of the third adder.

In this embodiment of this disclosure, the multiplier is configured to respectively multiply all mantissa parts that are obtained after splitting and that include the first high-order mantissa and the first low-order mantissa by all mantissa parts that are obtained after splitting and that include the second high-order mantissa and the second low-order mantissa, to obtain a plurality of pieces of multiplication data. The shift register is configured to perform shift processing on the plurality of pieces of multiplication data based on the second number of shifted bits of each mantissa part obtained after splitting. The third adder is configured to perform an addition operation on the plurality of pieces of multiplication data obtained after shift processing, to obtain a product of a mantissa part of a first floating-point number and a mantissa part of a second floating-point number.

### Example 1

FIG. 6 is a schematic diagram of another embodiment of a floating-point number calculation circuit according to an embodiment of this disclosure.

Refer to FIG. 6. If both the first floating-point number A and the second floating-point number B are FP32 floating-point numbers, when the FP32 floating-point numbers are calculated, the mantissa part of the first floating-point number is split into two parts: A_{MSB} and A_{LSB}. The mantissa part of the second floating-point number is split into two parts: B_{MSB} and B_{LSB}. A_{MSB}, A_{LSB}, B_{MSB}, and B_{LSB} are all 12 bits. In this case, a multiplication of the mantissa part of the first floating-point number A and the mantissa part of the second floating-point number B may be represented as a formula 1.

$$\begin{matrix}{\text{A}}_{\text{mantissa}} ∗ {\text{B}}_{\text{mantissa}} \\ = \left({\text{A}}_{\text{MSB}} + {\text{A}}_{\text{LSB}} ≫ 12 \text{bit}\right) ∗ \left({\text{B}}_{\text{MSB}} + {\text{B}}_{\text{LSB}} ≫ 12 \text{bit}\right) \\ = {\text{A}}_{\text{MSB}} ∗ {\text{B}}_{\text{MSB}} + {\text{A}}_{\text{MSB}} ∗ {\text{B}}_{\text{LSB}} ≫ 12 \text{bit} + {\text{A}}_{\text{LSB}} ∗ {\text{B}}_{\text{MSB}} ≫ \\ 12 \text{bit} + {\text{A}}_{\text{LSB}} ∗ {\text{B}}_{\text{LSB}} ≫ 24 \text{bit}\end{matrix} \qquad \text{Formula 1:}$$

As shown in FIG. 6, an exponential part corresponding to A_{MSB} is A_EXP, and an exponential part corresponding to B_{MSB} is B_EXP. A number of shifted bits A_{MSB} obtained by a splitting circuit is 0, and a number of shifted bits B_{MSB} is also 0. Therefore, an EXP offset (a first adder) adds results of A_{MSB}–0 and B_{MSB}–0 to obtain A_EXP+B_EXP. A_EXP+B_EXP is the second operation result corresponding to A_{MSB} _{*} B_{MSB}. The second operation result may indicate an operation result obtained after exponential parts corresponding to A_{MSB} _{*} B_{MSB} are multiplied.

The exponential part corresponding to A_{MSB} is A_EXP, and an exponential part corresponding to B_{LSB} is B_EXP. A number of shifted bits A_{MSB} obtained by the splitting circuit is 0, and a number of shifted bits B_{LSB} is –12. For ease of calculation, the number of shifted bits –12 can be split into –6 and –6, and exponential parts are respectively denoted as A_EXP–6 and B_EXP–6. The EXP offset (the first adder) adds results of A_{MSB}–6 and B_{LSB}–6 to obtain A_EXP+B_EX_12. A_EXP+B_EXP–12 is the second operation result corresponding to A_{MSB} _{*} B_{LSB}. The second operation result may indicate an operation result obtained after exponential parts corresponding to A_{MSB} * B_{LSB} are multiplied.

The exponential part corresponding to A_{LSB} is A_EXP, and an exponential part corresponding to B_{MSB} is B_EXP. A number of shifted bits A_{LSB} obtained by the splitting circuit is –12, and a number of shifted bits B_{MSB} is 0. For ease of calculation, the number of shifted bits –12 can be split into –6 and –6, and exponential parts are respectively denoted as A_EXP–6 and B_EXP–6. The EXP offset (the first adder) adds results of A_{L}_{SB}–6 and B_{MSB}–6 to obtain A_EXP+B_EXP–12. A_EXP+B_EXP–12 is the second operation result corresponding to A_{LSB} _{*} B_{MSB}. The second operation result may indicate an operation result obtained after exponential parts corresponding to A_{LSB} * B_{MSB} are multiplied.

The exponential part corresponding to A_{LSB} is A_EXP, and an exponential part corresponding to B_{LSB} is B_EXP. A number of shifted bits A_{LSB} obtained by the splitting circuit is –12, and a number of shifted bits B_{LSB} is –12. The EXP offset (the first adder) adds results of A_{LSB}–12 and B_{LSB}–12 to obtain A_EXP+B_EXP–24. A_EXP+B_EXP–24 is the second operation result corresponding to A_{LSB} _{*} B_{LSB}. The second operation result may indicate an operation result obtained after exponential parts corresponding to A_{LSB} _{*} B_{LSB} are multiplied.

After the plurality of second operation results are obtained through calculation, the selection circuit obtains MAX EXP (the largest value in the plurality of second operation results), and then inputs MAX EXP to each delta (the second adder). Each delta subtracts each second operation result from MAX EXP, to obtain the second number of shifted bits of each mantissa part obtained after splitting.

Each 13-bit Mul unit (the multiplier) separately calculates A_{MSB} _{*} B_{MSB}, A_{MSB} _{*} B_{LSB}, A_{LSB} _{*} B_{MSB}, and A_{LSB} _{*} B_{LSB} to obtain a plurality of pieces of multiplication data. A shift (shift register) shifts each part of input multiplication data after receiving each second number of shifted bits sent by each delta. An adder (the third adder) adds a plurality of pieces of multiplication data obtained after shifting, to obtain the product of the mantissa part of the first floating-point number and the mantissa part of the second floating-point number.

In this embodiment, optionally, the number of shifted bits –12 may alternatively be split in another manner, and may be split into –3 and –9, –4 and –8, or a plurality of other split manners, provided that a sum of numbers of shifted bits of two parts obtained after splitting is –12. This is not specifically limited herein. Similarly, the number of shifted bits –24 may alternatively be split in different manners. This is not specifically limited herein.

In this embodiment, optionally, the number of shifted bits –12 may alternatively be split in another manner, and may be split into –3 and –9, –4 and –8, or a plurality of other split manners, provided that a sum of numbers of shifted bits of two parts obtained after splitting is –12. This is not specifically limited herein. Similarly, the number of shifted bits –24 may alternatively be split in different manners. This is not specifically limited herein.

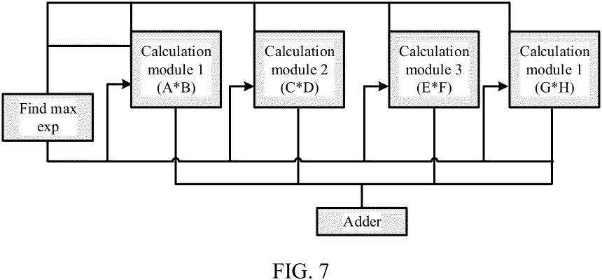

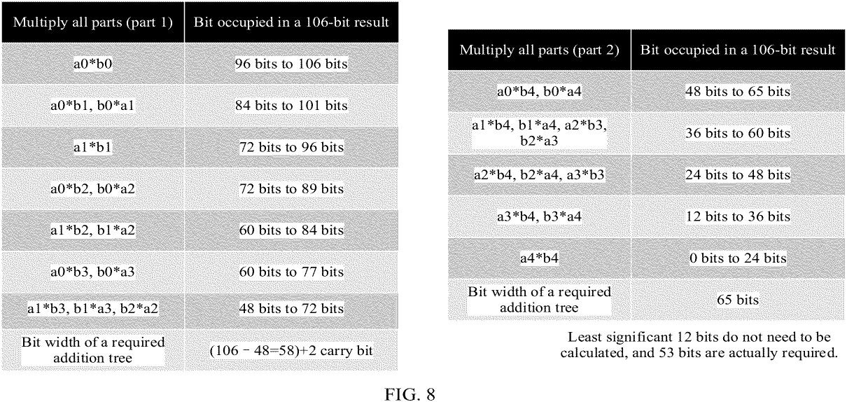

FIG. 7 is a schematic diagram of another embodiment of a floating-point number calculation circuit according to an embodiment of this disclosure.

In this embodiment of this disclosure, refer to FIG. 7. The embodiment shown in FIG. 6 is considered as a calculation module. When a plurality of calculation modules performs a multiplication operation on a plurality of pairs of floating-point numbers, the selection circuit may select a largest value (max exp) in all second operation results in the plurality of calculation modules, and return the largest value in all second operation results to each calculation module. All calculation modules obtain, based on the largest value in all the second operation results, second numbers of shifted bits of all mantissa parts obtained after splitting.

Example 2: If both the first floating-point number A and the second floating-point number B are FP64 floating-point numbers, when the FP64 floating-point numbers are calculated, the mantissa part of the first floating-point number is split into five parts: a0, a1, a2, a3, a4, and a5. The mantissa part of the first floating-point number is split into five parts: b0, b1, b2, b3, b4, and b5. a1, a2, a3, a4, b1, b2, b3, and b4 are all 12 bits, and a0 and b0 are 5 bits. A multiplication of the mantissa part of the first floating-point number A and the mantissa part of the second floating-point number B may be represented as a formula 2.

$$\begin{matrix}{\text{A}}_{\text{mantissa}} ∗ {\text{B}}_{\text{mantissa}} \\ = \begin{matrix}\left(\text{a0} ≪ \text{48bit} + \text{a1} ≪ 36 \text{bit} + \text{a2} ≪ \text{24bit} + \text{a3} ≪ 12 \text{bit} + \text{a4}\right) ∗ \\ \left(\text{b0} ≪ \text{48bit} + \text{b1} ≪ 36 \text{bit} + \text{b2} ≪ \text{24bit} + \text{b3} ≪ 12 \text{bit} + \text{b4}\right)\end{matrix} \\ = \text{a0} ∗ \text{b0} ≪ 96 \text{bit} \\ \text{+} \left(\text{a0} ∗ \text{b1} + \text{b0} ∗ \text{a1}\right) ≪ 84 \text{bit} \\ \text{+} \left(\text{a0} ∗ \text{b2} + \text{b0} ∗ \text{a2} + \text{a1} ∗ \text{b1}\right) ≪ 72 \text{bit} \\ \text{+} \left(\text{a0} ∗ \text{b3} + \text{b0} ∗ \text{a3} + \text{a1} ∗ \text{b2} + \text{b1} ∗ \text{a2}\right) ≪ 60 \text{bit} \\ \text{+} \left(\text{a0} ∗ \text{b4} + \text{b0} ∗ \text{a4} + \text{a1} ∗ \text{b3} + \text{b1} ∗ \text{a3} + \text{b2} ∗ \text{a2}\right) ≪ 48 \text{bit} \\ \text{+} \left(\text{a1} ∗ \text{b4} + \text{b1} ∗ \text{a4} + \text{a2} ∗ \text{b3} + \text{b2} ∗ \text{a3}\right) ≪ 36 \text{bit} \\ \text{+} \left(\text{a2} ∗ \text{b4} + \text{b2} ∗ \text{a4} + \text{a3} ∗ \text{b3}\right) ≪ 24 \text{bit} \\ \text{+} \left(\text{a3} ∗ \text{b4} + \text{b3} ∗ \text{a4}\right) ≪ 12 \text{bit} \\ + \text{a4} ∗ \text{b4}\end{matrix} \qquad \text{Formula 2:}$$

A process in which the exponential processing circuit and the calculation circuit calculate the product of the first floating-point number and the mantissa part of the second floating-point number is similar to that in the embodiment shown in Example 1. Details are not described herein again.

In this embodiment, because a length of the mantissa part of the FP64 floating-point number is 53 bits, a total length of mantissa parts obtained after calculation of A_mantissa*B_mantissa is 106 bits. To directly calculate mantissa parts of a pair of FP64 floating-point numbers in one calculation module, the adder (the third adder) needs to be extended to support calculation of 106-bit data. However, both area costs and timing costs of the extended adder are extremely high. Therefore, mantissas of the pair of FP64 floating-point numbers can be split into two parts for multiplication.

FIG. 8 is a schematic diagram of another embodiment of a floating-point number calculation circuit according to an embodiment of this disclosure.

Refer to FIG. 8. In this embodiment, optionally, the floating-point number calculation circuit may combine 13 pairs of high-order parts to form a high-order part (part 1), and combine 12 pairs of low-order parts to form another part (part 2). The high-order part needs an addition tree with a total width of 60 bits, and 53 bits in the low-order part need to be calculated.

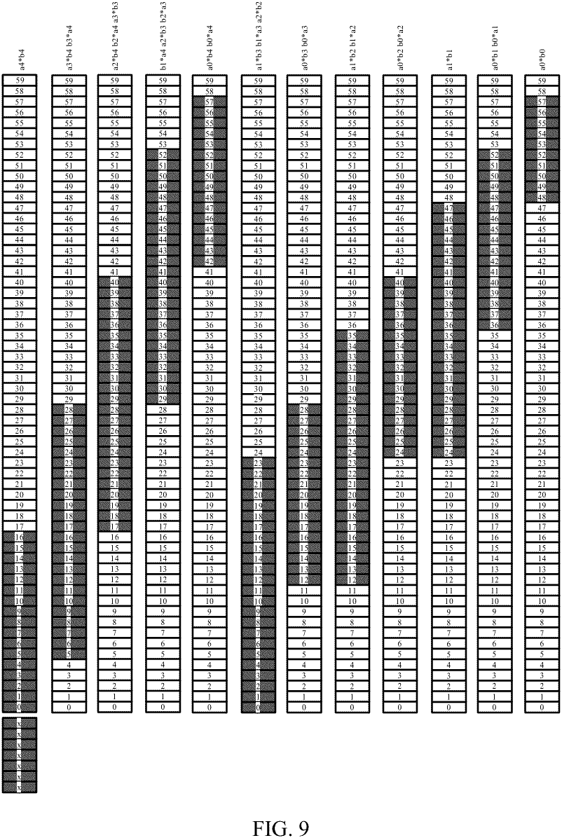

FIG. 9 is a schematic diagram of another embodiment of a floating-point number calculation circuit according to an embodiment of this disclosure.

FIG. 9 separately shows corresponding locations of calculation results that are obtained after all parts of the part 1 and the part 2 are calculated and that are in the addition tree. The 60-bit addition tree can cover calculation of the part 1. During calculation of the part 2, several least significant bits cannot be completely covered by the addition tree, but these bits do not participate in the calculation. When this part of data that cannot be covered by the addition tree is processed, this part of data may be stored, and then this part of stored data is used for subsequent calculation, or this part of data may be directly truncated. This is not specifically limited herein.

The floating-point number calculation circuit provided in this embodiment of this disclosure may be used in a CNN. A specific application process is described in detail in the following embodiment.

It is assumed that both a first floating-point number A and a second floating-point number B are FP32 floating-point numbers, and the first floating-point number A is data in a feature map.

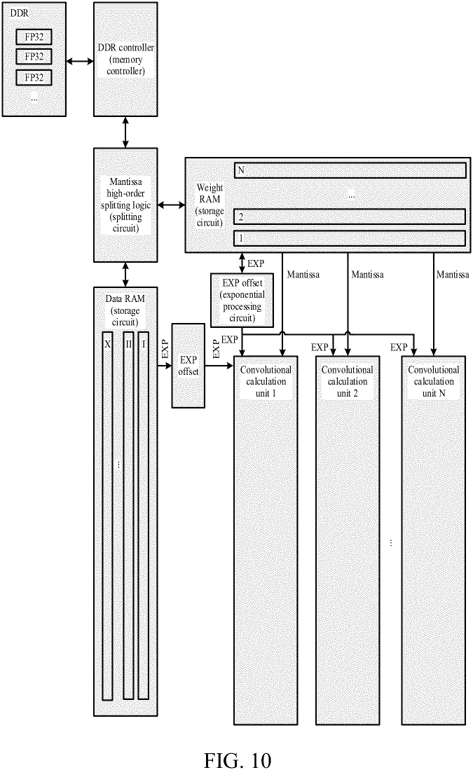

FIG. 10 is a schematic diagram of another embodiment of a floating-point number calculation circuit according to an embodiment of this disclosure.

Step 1: Refer to FIG. 10, the second floating-point number B is data in a filter matrix. A DDR controller (memory controller) reads a plurality of first floating-point numbers A and second floating-point numbers B from a DDR (memory). A mantissa part of the first floating-point number A is divided into two parts: MSB and LSB by using high-order and low-order splitting logic (splitting circuit), and the two parts are stored into a data random-access memory (RAM) (storage circuit). Content included in I, II, ..., and X in FIG. 10 is A_MSB and A_LSB obtained after the mantissa of each first floating-point number A is split, and exponential parts EXP corresponding to each A_MSB and A_LSB. A mantissa part of the second floating-point number B is split into two parts: MSB and LSB, and the two parts are stored in a weight RAM (storage circuit). Content included in 1, 2, and N in FIG. 10 is B_MSB and B_LSB obtained after the mantissa of each second floating-point number B is split, and exponential parts EXP corresponding to each B_MSB and B_LSB.

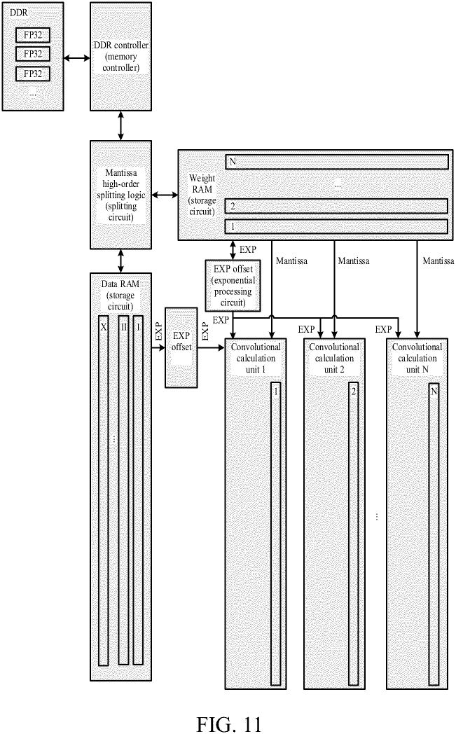

FIG. 11 is a schematic diagram of another embodiment of a floating-point number calculation circuit according to an embodiment of this disclosure.

Step 2: Refer to FIG. 11. The mantissa that is obtained after splitting and that is in the weight RAM is preloaded to a convolutional calculation unit, and EXP (an exponential part corresponding to each mantissa part obtained after splitting) is also preloaded to the convolutional calculation unit after being processed by an EXP offset (second adder).

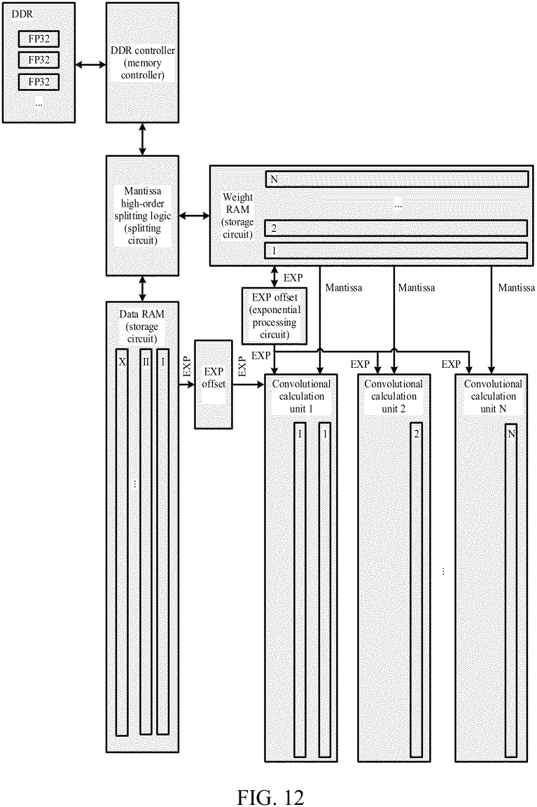

FIG. 12 is a schematic diagram of another embodiment of a floating-point number calculation circuit according to an embodiment of this disclosure.

Step 3: Refer to FIG. 12. A first segment of mantissa data (part I) is extracted from the data RAM. An EXP part is also placed in the convolutional calculation unit after being processed by the exp offset, and is calculated together with a preloaded parameter (part 1) to obtain a result.

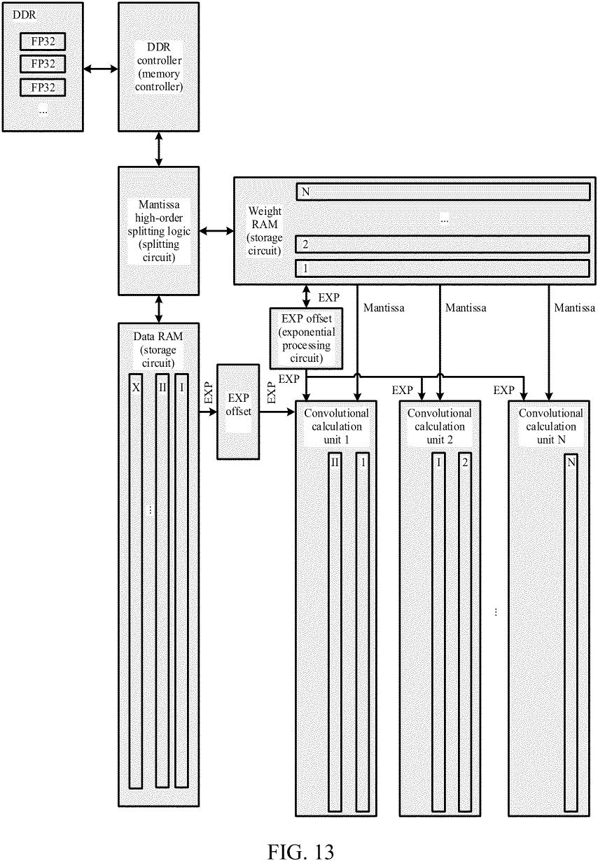

FIG. 13 is a schematic diagram of another embodiment of a floating-point number calculation circuit according to an embodiment of this disclosure.

Step 4: Refer to FIG. 13. A convolution processing unit 1 forwards the first segment of data (part I) to a calculation unit 2, and obtains a second segment of data (part II) from the data RAM. After a calculation unit 1 obtains the data of the part II, and the calculation unit 2 obtains the data of the part I, an operation is completed to generate a result. Then, at each clock, calculation units 2-N forward data processed by a previous clock to next calculation units, and the calculation unit 1 obtains new data from the data RAM each time.

Step 5: Repeat the step 4 until all data is calculated, to generate a result.

The floating-point number calculation circuit and the floating-point number calculation method provided in embodiments of this disclosure are described in detail above. The principle and implementations of this disclosure are described herein through specific examples. The foregoing embodiments are merely intended to help understand the method and core idea of this disclosure. In addition, a person of ordinary skill in the art may make variations and modifications to this disclosure in terms of the specific implementations and application scopes based on the ideas of this disclosure. Therefore, the content of this specification shall not be construed as a limitation to this disclosure.

What is claimed is:

1. A floating-point number calculation circuit, wherein the floating-point number calculation circuit comprises:
a memory controller comprising a first output terminal and configured to obtain a first floating-point number and a second floating-point number;
a splitting circuit comprising:
a first input terminal electrically connected to the first output terminal; and
a second output terminal,
wherein the splitting circuit is configured to:
split a first mantissa part of the first floating-point number to obtain a split first mantissa part;
split a second mantissa part of the second floating-point number to obtain a split second mantissa part;
obtain a first number of shifted bits of the split first mantissa part; and
obtain a second number of shifted bits of the split second mantissa part;
a storage circuit comprising:
a second input terminal connected to the second output terminal;
a third output terminal; and
a fourth output terminal,
wherein the storage circuit is configured to store the split first mantissa part, the split second mantissa part, a first exponential part corresponding to the split first mantissa part, a second exponential part corresponding to the split second mantissa part, the first number, and the second number;
an exponential processing circuit comprising:
a third input terminal electrically connected to the third output terminal; and
a fifth output terminal,
wherein the exponential processing circuit is configured to:
add a third exponential part of the first floating-point number and a fourth exponential part of the second floating-point number to obtain a first operation result;
add the first number, the second number, the first exponential part, and the second exponential part to obtain a plurality of second operation results; and
obtain, based on the plurality of second operation results, a third number of shifted bits of the split first mantissa part and a fourth number of shifted bits of the split second mantissa part; and
a calculation circuit comprising:
a fourth input terminal electrically connected to the fourth output terminal; and
a fifth input terminal electrically connected to the fifth output terminal,
wherein the calculation circuit is configured to calculate, based on the split first mantissa part, the split second mantissa part, the third number, and the fourth number, a product of the first mantissa part and the second mantissa part.

2. The floating-point number calculation circuit of claim 1, wherein the splitting circuit is further configured to:
split the first mantissa part into a first high-order mantissa and a first low-order mantissa; and
split the second mantissa part into a second high-order mantissa and a second low-order mantissa,
wherein the first number indicates a first shift difference between a first most significant bit of the first high-order mantissa and a second most significant bit of the first low-order mantissa, and
wherein the second number indicates a second shift difference between a third most significant bit of the second high-order mantissa and a fourth most significant bit of the second low-order mantissa.

3. The floating-point number calculation circuit of claim 2, wherein the first high-order mantissa comprises a first mantissa, wherein the first low-order mantissa comprises a second mantissa, wherein the second high-order mantissa comprises a third mantissa, and wherein the second low-order mantissa comprises a fourth mantissa.

4. The floating-point number calculation circuit of claim 3, wherein the exponential processing circuit further comprises:
a first adder comprising:
a sixth input terminal electrically connected to the third output terminal; and
a sixth output terminal,
wherein the first adder is configured to add the first number, the second number, the first exponential part, and the second exponential part to obtain the plurality of second operation results;
a second adder comprising:
a seventh input terminal electrically coupled to the sixth output terminal;
an eighth input terminal; and
an eighth output terminal electrically connected to the fourth input terminal,
wherein the second adder is configured to subtract each of the plurality of second operation results from a largest value in the plurality of second operation results to obtain the third number and the fourth number; and
a selection circuit comprising a seventh output terminal electrically connected to the eight input terminal and configured to select the largest value.

5. The floating-point number calculation circuit of claim 4, wherein the calculation circuit further comprises:
a multiplier comprising:
a ninth input terminal electrically connected to the fourth output terminal; and
a ninth output terminal;
wherein the multiplier is configured to multiply the first mantissa part by the second mantissa part to obtain a plurality of pieces of multiplication data;
a shift register comprising:
a tenth input terminal electrically connected to the ninth output terminal; and
a tenth output terminal,
wherein the shift register is configured to perform, based on the third number and the fourth number, shift processing on the plurality of pieces of multiplication data to obtain a shifted plurality of pieces of multiplication data; and
a third adder comprising an eleventh input terminal electrically connected to the tenth output terminal and configured to perform an addition operation on the shifted plurality of pieces of multiplication data to obtain the product.

6. The floating-point number calculation circuit of claim 2, wherein the first high-order mantissa comprises a first mantissa, wherein the first low-order mantissa comprises a second mantissa, a third mantissa, a fourth mantissa, and a fifth mantissa, wherein the second high-order mantissa comprises a sixth mantissa, and wherein the second low-order mantissa comprises a seventh mantissa, an eighth mantissa, a ninth mantissa, and a tenth mantissa.

7. A floating-point number calculation method, comprising:
obtaining a first floating-point number and a second floating-point number;
splitting a first mantissa part of the first floating-point number to obtain a split first mantissa part;
splitting a second mantissa part of the second floating-point number to obtain a split second mantissa part;
obtaining a first number of shifted bits of the split first mantissa part;
obtaining a second number of shifted bits of the split second mantissa part;
storing the split first mantissa part, the split second mantissa part, a first exponential part corresponding to the split first mantissa part, a second exponential part corresponding to the split second mantissa part, the first number, and the second number;
adding a third exponential part of the first floating-point number and a fourth exponential part of the second floating-point number to obtain a first operation result;
adding the first number, the second number, the first exponential part, and the second exponential part to obtain a plurality of second operation results;
obtaining, based on the plurality of second operation results, a third number of shifted bits of the split first mantissa part and a fourth number of shifted bits of the split second mantissa part; and
calculating, based on the split first mantissa part, the split second mantissa part, the third number, and the fourth number, a product of the first mantissa part and the second mantissa part.

8. The floating-point number calculation method of claim 7, wherein splitting the first mantissa part comprises splitting the first mantissa part into a first high-order mantissa and a first low-order mantissa, wherein splitting the second mantissa part comprises splitting the second mantissa part into a second high-order mantissa and a second low-order mantissa, wherein the first number indicates a first shift difference between a first most significant bit of the first high-order mantissa and a second most significant bit of the first low-order mantissa, and wherein the second number indicates a second shift difference between a third most significant bit of the second high-order mantissa and a fourth most significant bit of the second low-order mantissa.

9. The floating-point number calculation method of claim 8, wherein the first high-order mantissa comprises a first mantissa, wherein the first low-order mantissa comprises a second mantissa, wherein the second high-order mantissa comprises a third mantissa, and wherein the second low-order mantissa comprises a fourth mantissa.

10. The floating-point number calculation method of claim 8, wherein the first high-order mantissa comprises a first mantissa, wherein the first low-order mantissa comprises a second mantissa, a third mantissa, a fourth mantissa, and a fifth mantissa, wherein the second high-order mantissa comprises a sixth mantissa, and wherein the second low-order mantissa comprises a seventh mantissa, an eighth mantissa, a ninth mantissa, and a tenth mantissa.

11. A calculation apparatus, comprising:
a control circuit; and
a floating-point number calculation circuit configured to calculate under control of the control circuit, and wherein the floating-point number calculation circuit comprises:
a memory controller comprising a first output terminal and configured to obtain a first floating-point number and a second floating-point number;
a splitting circuit comprising:
a first input terminal electrically connected to the first output terminal; and
a second output terminal,
wherein the splitting circuit is configured to:
split a first mantissa part of the first floating-point number to obtain a split first mantissa part;
split a second mantissa part of the second floating-point number to obtain a split second mantissa part;
obtain a first number of shifted bits of the split first mantissa part; and
obtain a second number of shifted bits of the split second mantissa part;
a storage circuit comprising:
a second input terminal connected to the second output terminal;
a third output terminal; and
a fourth output terminal,
wherein the storage circuit is configured to store the split first mantissa part, the split second mantissa part, a first exponential part corresponding to the split first mantissa part, a second exponential part corresponding to the split second mantissa part, the first number, and the second number;
an exponential processing circuit comprising:
a third input terminal electrically connected to the third output terminal; and
a fifth output terminal,
wherein the exponential processing circuit is configured to:
add a third exponential part of the first floating-point number and a fourth exponential part of the second floating-point number to obtain a first operation result;
add the first number, the second number, the first exponential part, and the second exponential part to obtain a plurality of second operation results; and
obtain, based on the plurality of second operation results, a third number of shifted bits of the split first mantissa part and a fourth number of shifted bits of the split second mantissa part; and
a calculation circuit comprising:
a fourth input terminal electrically connected to the fourth output terminal; and
a fifth input terminal electrically connected to the fifth output terminal,
wherein the calculation circuit is configured to calculate, based on the split first mantissa part, the split second mantissa part, the third number, and the fourth number, a product of the first mantissa part and the second mantissa part.

12. The calculation apparatus of claim 11, wherein the splitting circuit is further configured to:
split the first mantissa part into a first high-order mantissa and a first low-order mantissa; and
split the second mantissa part into a second high-order mantissa and a second low-order mantissa,
wherein the first number indicates a first shift difference between a first most significant bit of the first high-order mantissa and a second most significant bit of the first low-order mantissa, and
wherein the second number indicates a second shift difference between a third most significant bit of the second high-order mantissa and a fourth most significant bit of the second low-order mantissa.

13. The calculation apparatus of claim 12, wherein the first high-order mantissa comprises a first mantissa, wherein the first low-order mantissa comprises a second mantissa, wherein the second high-order mantissa comprises a third mantissa, and wherein the second low-order mantissa comprises a fourth mantissa.

14. The calculation apparatus of claim 13, wherein the exponential processing circuit further comprises:
a first adder comprising:
a sixth input terminal electrically connected to the third output terminal; and
a sixth output terminal,
wherein the first adder is configured to add the first number, the second number, the first exponential part, and the second exponential part to obtain the plurality of second operation results;
a second adder comprising:
a seventh input terminal electrically coupled to the sixth output terminal;
an eighth input terminal electrically connected to a seventh output terminal of a selection circuit; and
an eighth output terminal electrically connected to the fourth input terminal,
wherein the second adder is configured to subtract each of the plurality of second operation results from a largest value in the plurality of second operation results to obtain the third number and the fourth number; and
the selection circuit comprising the seventh output terminal and configured to select the largest value.

15. The calculation apparatus of claim 14, wherein the calculation circuit further comprises:
a multiplier comprising:
a ninth input terminal electrically connected to the fourth output terminal; and
a ninth output terminal,
wherein the multiplier is configured to multiply the first mantissa part by the second mantissa part to obtain a plurality of pieces of multiplication data;
a shift register comprising:
a tenth input terminal electrically connected to the ninth output terminal; and
a tenth output terminal,
wherein the shift register is configured to perform, based on the third number and the fourth number, shift processing on the plurality of pieces of multiplication data to obtain a shifted plurality of pieces of multiplication data; and
a third adder comprising an eleventh input terminal electrically connected to the tenth output terminal,
wherein the third adder is configured to perform an addition operation on the shifted plurality of pieces of multiplication data to obtain the product.

16. The calculation apparatus of claim 12, wherein the first high-order mantissa comprises a first mantissa, wherein the first low-order mantissa comprises a second mantissa, a third mantissa, a fourth mantissa, and a fifth mantissa, wherein the second high-order mantissa comprises a sixth mantissa, and wherein the second low-order mantissa comprises a seventh mantissa, an eighth mantissa, a ninth mantissa, and a tenth mantissa.

17. The calculation apparatus of claim 11, wherein the first floating-point number and the second floating-point number comprise floating-point 32 (FP32) data.

18. The calculation apparatus of claim 11, wherein the first floating-point number and the second floating-point number comprise floating-point 64 (FP64) data.

19. The calculation apparatus of claim 11, wherein the first floating-point number and the second floating-point number comprise floating-point 128 (FP128) data.

20. The calculation apparatus of claim 11, wherein the control circuit comprises a double data rate (DDR) controller.
